(19) United States
(12) Patent Application Publication
(10) Pub. No.: US 2009/0243404 A1
(43) Pub. Date: Oct. 1, 2009

(54) Vibrator, controlling method thereof and portable terminal provided with the same

(75) Inventors: Ju Ho Kim, Gyeonggi-do (KR); Dong Jin Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/213,361

(22) Filed: Jun. 18, 2008

(30) Foreign Application Priority Data
Mar. 28, 2008 (KR) 10-2008-0028967

(51) Int. Cl. H02K 33/00

(52) U.S. Cl. 310/25

(57) ABSTRACT

In accordance with the present invention, a vibrator including a case; an elastic member installed inside the case and made of shape memory alloy of which physical properties are varied as power is applied from an outside of the case; a vibrating body elastically installed inside the case by the elastic member; and a coil installed inside the case and vibrating the vibrating body as the power is applied from the outside.

### CROSS-REFERENCE TO RELATED APPLICATIONS

This application claims the benefit of Korean Patent Application No. 10-2008-0028967 filed with the Korea Intellectual Property Office on Mar. 28, 2008, the disclosure of which is incorporated herein by reference.

### BACKGROUND OF THE INVENTION

1. Field of the Invention

The present invention relates to a vibrator; and, more particularly, to a vibrator capable of realizing various vibration modes, a controlling method thereof and a portable terminal provided with the same.

2. Description of the Related Art

Various kinds of vibration generation devices have been mounted on a cellular phone, a currently used representative portable terminal, to generate vibration used as a receiving signal.

A vibration motor mostly used as the vibration generation devices is constructed to generate vibration by converting electric energy into mechanical energy and rotating an eccentric weight by the converted mechanical energy.

FIG. 1 is a longitudinal cross sectional view of a conventional flat type vibration motor 100 used as a vibration generation device.

As shown in FIG. 1, the conventional flat type vibration motor 100 consists of a rotor assembly 110, a stator assembly 130 and a case 102 for receiving the rotor assembly 110 and stator assembly 130.

At this time, the rotor assembly has a winding coil 114, a commutator 116 and a weight body 118.

Meanwhile, the winding coil 114 and the weight body 118 are installed on an upper part of an insulator 112 which is rotatably installed on a shaft 122 vertically mounted inside the case 102.

Meanwhile, on a lower part of the insulator 112, there is mounted an upper substrate 124 and on a bottom surface of the upper substrate 124, there is mounted the commutator 116 having a plurality of divided segments at predetermined intervals in a circumferential direction.

At this time, the commutator 116 is electrically connected to the winding coil 114.

And, the stator assembly 130 has a bracket 132, a magnet 134 and a brush 136.

That is, as shown in FIG. 1, a lower substrate 135 is fixed on a top surface of the bracket 132 and the bracket 132 is connected to an opened lower part of the case 102.

On a top surface of the lower substrate 135, the ring-shaped magnet 134 and the brush 136 are fixed, and the brush 136 is electrically connected to an external power source through the lower substrate 135.

At this time, the brush 136 supplies current to the winding coil 114 through the commutator 116 when a top end thereof comes in contact with the commutator 116 by connecting the bracket 132 to the lower part of the case 102.

Meanwhile, on the lower substrate 135, there is installed a power supply unit 140 electrically connected to the external power source and consisting of an ode and cathode terminals 142a and 142b and lead wires 144a and 144b.

That is, the lower substrate 135 has a terminal unit 135a projected outside the case 102 and the anode and cathode terminals 142a and 142b are formed on a top surface of the terminal unit 135a. And, the anode and cathode terminals 142a and 142b are electrically connected to the lead wires 144a and 144b electrically connected to the external power source.

Therefore, in the vibration motor 100, the current is supplied from the external power source to the brush 136 through the lead wires 144a and 144b and the anode and cathode terminals 142a and 142b and thus the rotor assembly 110 is rotated by interaction between the winding coil 114 and the magnet 134 to generate vibration.

At this time, the commutator 116 of the rotor assembly 110 consists of the plurality of segments and comes into contact with the upper end of the brush 136 when the rotor assembly 110 is rotated, thereby generating mechanical friction and an electric spark between the brush 136 and the commutator 116 to damage them.

Accordingly, there was caused a problem that the lifetime of the vibration motor 100 is reduced by deterioration of durability thereof.

Further, because the vibration motor 100 has a structure that the rotor assembly 110 is rotated about the shaft 122, a space for the rotation of the rotor assembly 110 needs to be secured inside the case 102, and therefore it is difficult to be downsized.

Accordingly, there was a limit in applying the vibration motor as the vibration generation device of the gradually downsized cellular phone.

And, when mounting the vibration motor 100 in the cellular phone, there were disadvantages that an additional space for the power supply unit 140 formed on the terminal unit 135a projected outside the case needs to be prepared and the lead wires 144a and 144b should be electrically connected to the external power source.

Meanwhile, the lead wires 144a and 144b and the external power source are electrically connected by soldering or the like. At this time, there was caused a problem that an error rate of the cellular phone was increased by frequent occurrence of errors such as breaking down of a wire or short-circuit due to soldering defect.

Further, there was a problem that a space in the cellular phone is narrow and it is not easy to wire the lead wires 144a and 144b.

### SUMMARY OF THE INVENTION

The present invention has been invented in order to overcome the above-described several disadvantages and problems according to the background of the invention. It is, therefore, an object of the present invention to provide a vibrator capable of realizing the downsizing and the diversifying of a vibration mode and improving performance, a controlling method thereof and a portable terminal provided with the same.

In accordance with an aspect of the present invention, there is provided a vibrator including a case; an elastic member installed inside the case and made of shape memory alloy of which physical properties are varied as power is applied from an outside of the case; a vibrating body elastically installed inside the case by the elastic member; and a coil installed inside the case and vibrating the vibrating body as the power is applied from the outside.

The case may have a predetermined thickness to form a space inside and be formed in a cylindrical shape with an opened lower part and include a support member installed on a lower part of the case to fix the coil on a top surface of the support member.

Herein, the support member may be a substrate with a connection device formed on a bottom surface for applying power to the coil.

At this time, the connection device may be a metallic member or a conductive pattern electrically connected to the coil.

The elastic member may be made of Ni—Ti alloy of which physical properties such as an elastic modulus and a yield strength are varied as a martensite phase and an austenite phase.

At this time, the Ni—Ti alloy is preferably in the ratio of 55% of Ni and 45% of Ti.

And, the elastic member may be a plate type spring of which an outer part is fixed to an inside surface of an upper part of the case and a central part is fixed to the vibrating body.

At this time, the plate type spring may be composed of a plurality of types divided with respect to the central part bidirectionally.

And, the elastic member may be a spiral spring of which an outer part is fixed inside the upper part of the case and a central part is fixed to the vibrating body.

At this time, the spiral spring may include an outer ring unit for forming the outer part, an inner ring unit for forming the central part and an arch unit for connecting the outer ring unit and the inner ring unit.

The vibrating body may include a yoke for receiving elastic force in an axial direction of the case by being fixed to the elastic member; a weight body fixed to a circumference of the yoke; and a magnet fixed to a center of the yoke.

The coil may be a voice coil.

The vibrator may further include an elastic member power control unit for controlling the power applied to the elastic member; and a coil power control unit for controlling the power applied to the coil correspondingly to the power applied to the elastic member through the elastic member power control unit.

Herein, the coil power control unit may be constructed to supply the coil with the power with a frequency corresponding to the natural frequency of the vibrating body varied as the power is applied to the elastic member.

Meanwhile, in accordance with another aspect of the present invention, there is provided a controlling method of the vibrator including the steps of: selecting whether power is applied to an elastic member or not; controlling the power applied to the elastic member from an elastic member power control unit according to a power application state of the elastic member; and controlling the power applied to a coil from a coil power control according to the power application state of the elastic member.

Herein, the step of controlling the power applied to the coil may be include a step of applying to the coil the power having a frequency corresponding to the natural frequency of the vibrating body varied according to the power application state of the elastic member from the coil power control unit.

In accordance with still another aspect of the present invention, there is provided a vibrator including a case with an external connection hole formed therein; an elastic member installed inside the case and made of shape memory alloy of which physical properties are varied as power is applied from an outside of the case; a vibrating body elastically installed inside the case by the elastic member; a coil installed inside the case and vibrating the vibrating body as the power is applied from the outside; and a vibration transmitting member for transferring outside the vibration generated from the vibrating body by one side thereof being connected to the rotating body and the other side thereof being extended outside the case.

The vibration transmitting member may be a shaft connected to an external device by one side thereof being connected to the rotating body and the other side thereof being extended outside the case through the external connection hole of the case.

The elastic member may be a plate type spring fixed to the vibrating body such that an outer part is fixed inside the case and a central part is not interfered with a shaft.

Further, the elastic member may be a spiral spring fixed to the vibrating body such that the outer part is fixed to an inside surface of the case and the central part is not interfered with the shaft.

The vibrator may further include an elastic member power control unit for controlling the power applied to the elastic member; and a coil power control unit for controlling the power applied to the coil correspondingly to the power applied to the elastic member through the elastic member power control unit.

Herein, the coil power control unit may be constructed to supply the coil with the power with a frequency corresponding to the natural frequency of the vibrating body varied as the power is applied to the elastic member.

Meanwhile, in accordance with still another aspect of the present invention, there is provided a portable terminal provided with a vibrator including a case, an elastic member installed inside the case and made of shape memory alloy of which physical properties are varied as power is applied from an outside of the case, a vibrating body elastically installed inside the case by the elastic member, and a coil installed inside the case and vibrating the vibrating body as the power is applied from the outside.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic cross-sectional view showing a vibrator in accordance with a prior art;

FIG. 2 is a schematic cross-sectional view showing a vibrator in accordance with a first embodiment of the present invention;

FIG. 3 is a schematic cross-sectional view showing a state of being applied with power to an elastic member in FIG. 2;

FIG. 4 is a schematic perspective view showing a plate type spring applied as an elastic member in FIG. 2;

FIG. 5 is a perspective view showing another type of plate type spring in FIG. 4;

FIG. 6 to FIG. 11 are schematic plane-views showing a spiral spring applied as the elastic member in FIG. 2;

FIG. 12 is a schematic flowchart representing a method for controlling the vibrator in accordance with the first embodiment of the present invention;

FIG. 13 is a schematic cross-sectional view showing a vibrator applied with a flat plate type spiral spring;

FIG. 14 is a cross-sectional view taken along a line I-I line in FIG. 12;

FIG. 15 is a schematic cross-sectional view showing a vibrator in accordance with a second embodiment of the present invention; and

FIG. 16 is a schematic cross-sectional view showing another embodiment type of an elastic member in FIG. 15.

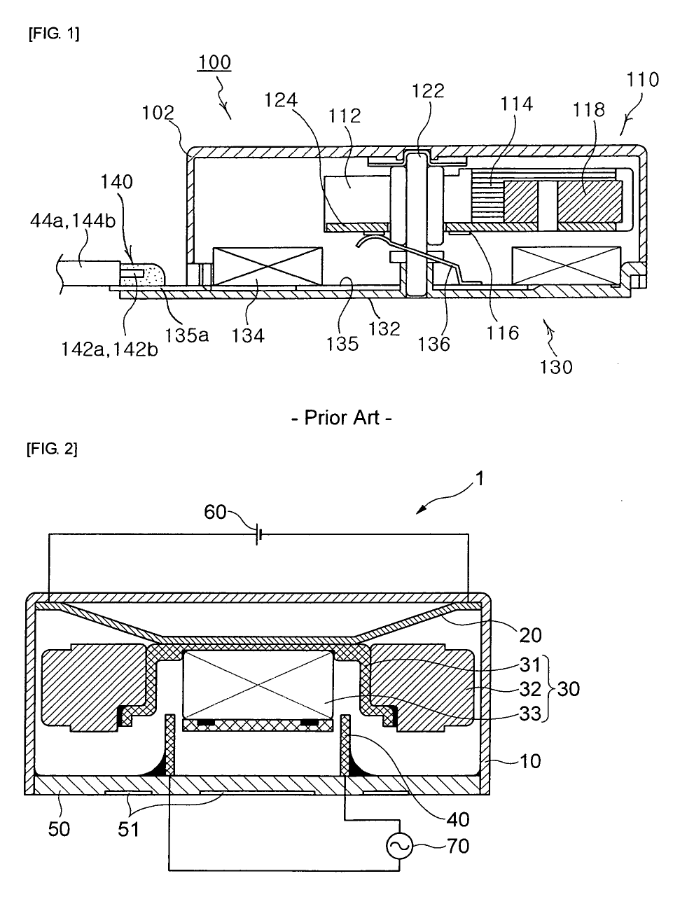

### DETAILED DESCRIPTION OF THE PREFERRED EMBODIMENTS

Hereinafter, a vibrator, a controlling method thereof and a portable terminal provided with the same in accordance with preferable embodiments of the present invention will be described in more detailed with reference to the accompanying drawings illustrating preferable embodiments of the present invention.

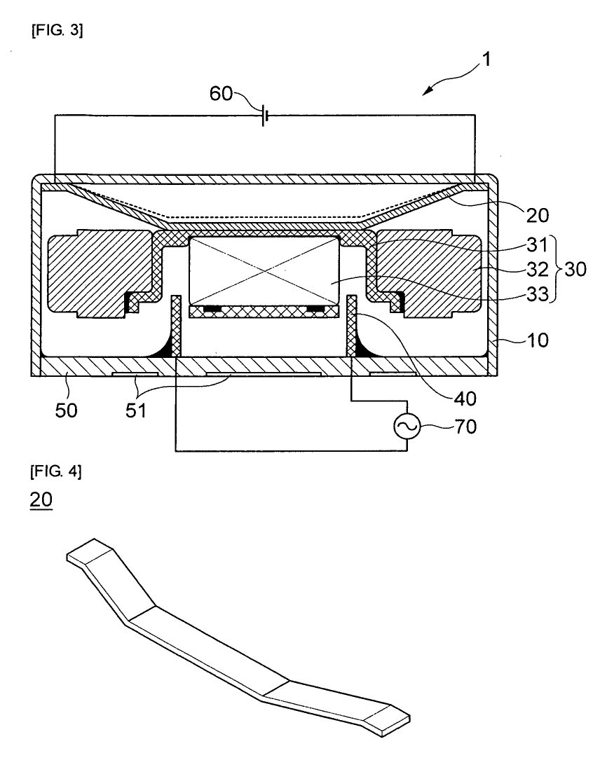

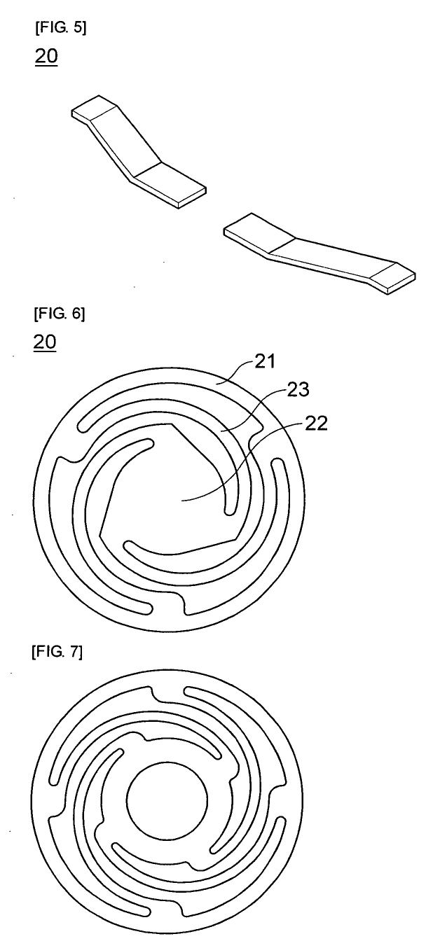

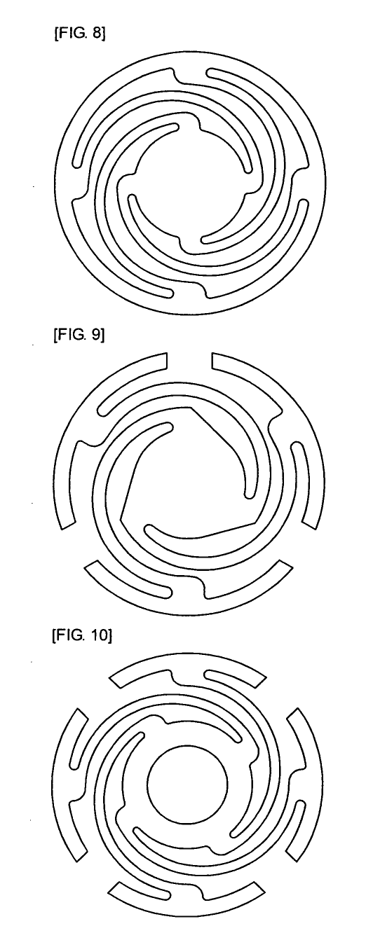

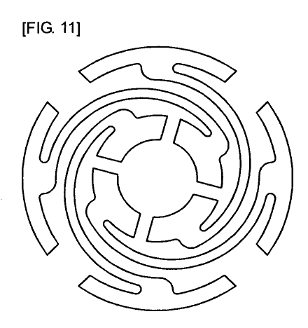

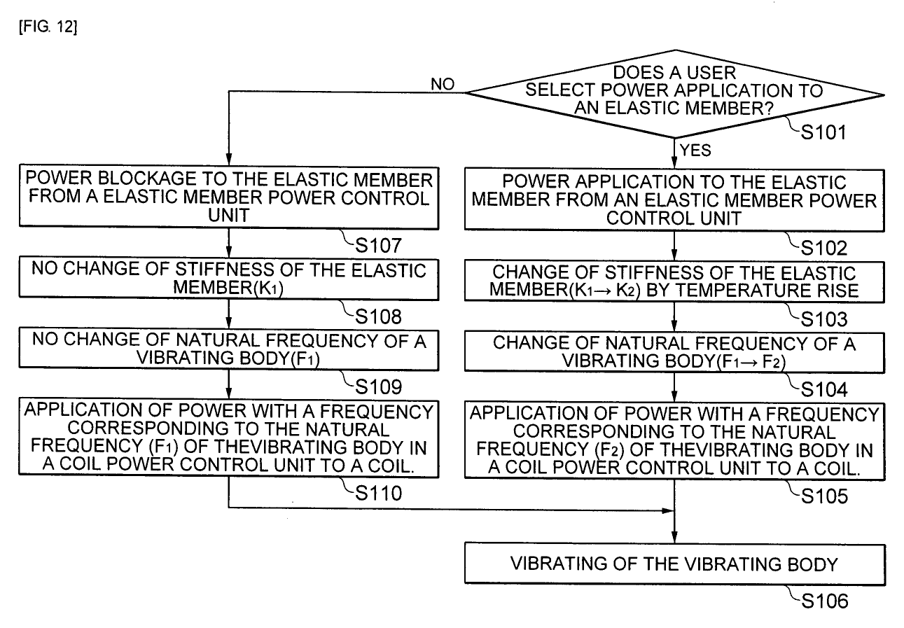

FIG. 2 is a schematic cross-sectional view showing a vibrator in accordance with a first embodiment of the present invention, FIG. 3 is a schematic cross-sectional view showing a state of being applied with power to an elastic member in FIG. 2, FIG. 4 is a schematic perspective view showing a plate type spring applied as an elastic member in FIG. 2, FIG. 5 is a perspective view showing another type of plate type spring in FIG. 4, FIG. 6 to FIG. 11 are schematic plane-views showing a spiral spring applied as the elastic member in FIG. 2, and FIG. 12 is a schematic flowchart representing a method for controlling the vibrator in accordance with the first embodiment of the present invention.

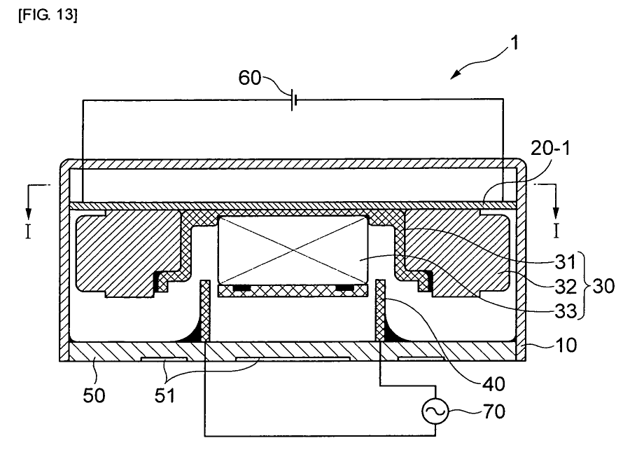

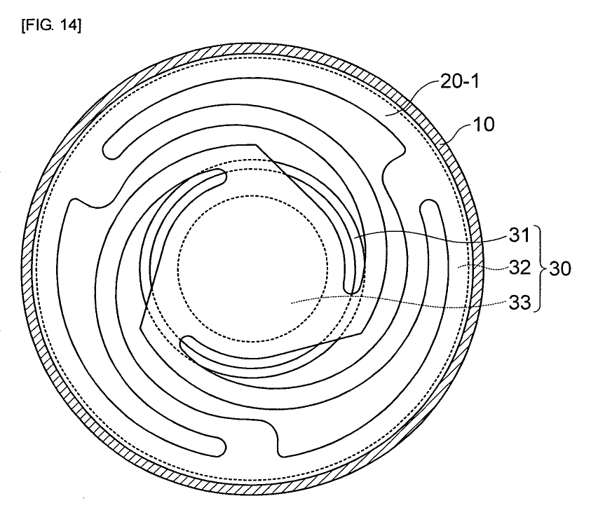

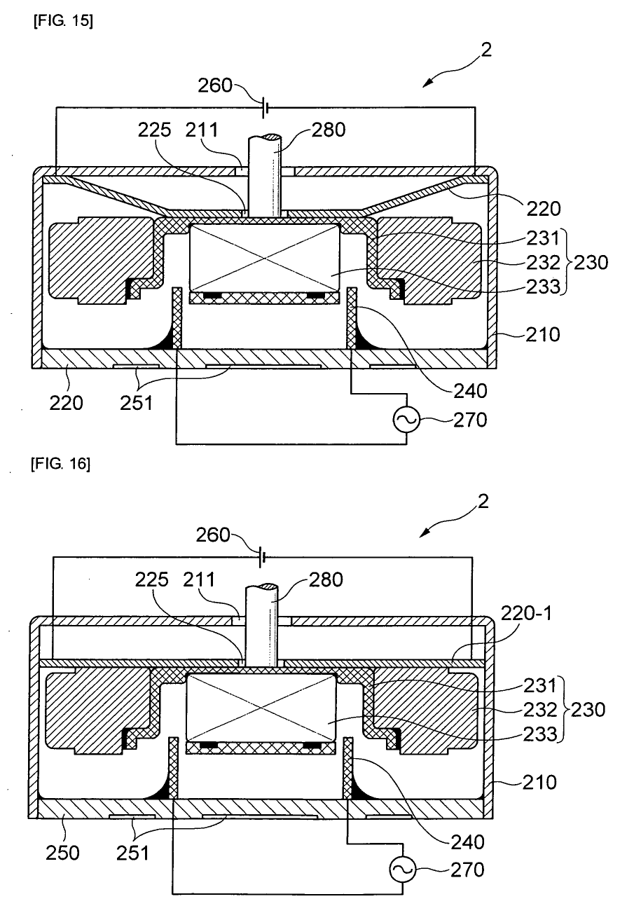

And, FIG. 13 is a schematic cross-sectional view showing a vibrator applied with a plate type spiral spring, FIG. 14 is a cross-sectional view taken along a line I-I line in FIG. 13, FIG. 15 is a schematic cross-sectional view showing a vibrator in accordance with a second embodiment of the present invention, and FIG. 16 is a schematic cross-sectional view showing another embodiment type of an elastic member in FIG. 15.

### First Embodiment for a Vibrator

A vibrator and a controlling method thereof in accordance with a first embodiment of the present invention will be described in more detail with reference to the accompanying FIG. 2 to FIG. 12.

As shown in FIG. 2, in accordance with the present invention, a vibrator 1 includes a case 10 for forming an appearance of the vibrator 1; an elastic member 20 installed inside the case 10 and made of shape memory alloy of which physical properties are varied as power is applied from an outside of the case 10; a vibrating body 30 elastically installed inside the case 10 by the elastic member 20; and a coil 40 installed inside the case 10 and vibrating the vibrating body 30 as the power is applied from the outside.

The case 10 may have a predetermined thickness to form a space inside and be formed in a cylindrical shape with an opened lower part.

That is, the elastic member 20 and the vibrating body 30 elastically supported by the elastic member 20 are installed by forming the space inside the case 10.

Meanwhile, a support member 50 may be installed on a lower part of the case 10 to fix the coil 40 on a top surface thereof.

Herein, the support member 50 may be a substrate with a connection device 51 formed on a bottom surface for applying the power to the coil 40.

At this time, the connection device 51 may be a metallic member or a conductive pattern electrically connected to the coil 40.

Accordingly, in accordance with the first embodiment of the present invention, the vibrator 1 is capable of being surface-mounted on a main board such as a portable terminal by the connection device 51 formed on the support member 50.

In addition, although not shown, in the vibrator 1 in accordance with the first embodiment of the present invention, instead of the forming of the connection device 51 on the support member 50, it is possible that the case 10 is installed inside a main body unit forming an appearance of the portable terminal and the coil 40 is electrically connected to the main board of the portable terminal through wiring.

Meanwhile, as shown in FIG. 4, the elastic member 20 may be a plate type spring of which an outer part is fixed to an inside surface of an upper part of the case 10 and a central part is fixed to the vibrating body 30.

At this time, as shown in FIG. 5, the plate type spring may be composed of a plurality of types divided with respect to the central part bidirectionally.

And, as shown in FIG. 6, the elastic member 20 may be a spiral spring of which an outer part is fixed to an inside surface of an upper part of the case 10 and a central part is fixed to the vibrating body 30.

At this time, the spiral spring includes an outer ring unit 21 for forming the outer part fixed inside the upper part of the case 10, an inner ring unit 22 for forming the central part fixed to the vibrating body 30 and an arch unit 23 for connecting the outer ring unit 21 and the inner ring unit 22.

Further, as shown in FIG. 7 to FIG. 11, the spiral spring may be formed to have various types of outer ring units, inner ring units and arch units.

Meanwhile, the vibrating body 30 may include a yoke 31 applied with elastic force in an axial direction of the case 10 by being fixed to the elastic member 20; a weight body 32 fixed to a circumference of the yoke 31; and a magnet 33 fixed to a center of the yoke 31.

That is, the vibrating body 30 may include the yoke 31 fixed to the central part of the elastic member 20; the weight body 32 having a minimum weight for vibration; and the magnet 33 for electromagnetically interacting with the coil 40.

Herein, the coil 40 may be a voice coil.

That is, the coil 40 is comprised of the voice coil and plays the role of generating vibration of the vibrating body 30 by transmitting to the vibrating body 30 electromagnetic force generated by interaction of one electric field generated by applying current and the other electric field generated from the magnet 33.

Meanwhile, the elastic member 20 may be made of Ni—Ti alloy of which physical properties such as an elastic modulus and a yield strength are varied as a martensite phase and an austenite phase.

At this time, the Ni—Ti alloy is preferably in the ratio of 55% of Ni and 45% of Ti.

That is, as represented in Table 1, the material state of the elastic member 20 is converted from a low temperature state, that is, a martensite structure, in a state that the (power) current is not applied into a high temperature state, that is, an austenite structure by increasing the temperature when the power (current) is applied, and the elastic modulus and the yield strength of the austenite phase are remarkably increased in comparison with those of the martensite phase.

TABLE 1

| | Martensite | | Austenite | |
|---|---|---|---|---|
| Density | 6.45 | g/cc | 6.45 | g/cc |
| Poisson's ratio | 0.3 | | 0.3 | |
| Elastic modulus | 28 | GPa | 75 | GPa |
| Yield strength | 100 | Mpa | 560 | Mpa |

That is to say, because the elastic member 20 is made of shape memory alloy, when the power (current) is applied, the material state of the elastic member is changed to the high temperature state, the shape thereof is changed as shown in FIG. 3 and the elastic modulus thereof is increased to increase the stiffness thereof.

Therefore, the elastic member 20 has a greater stiffness (K₂) by being applied with the power (current) than a stiffness (K₁) before the power is applied.

That is, as described above, when the stiffness (K₂) of the elastic member 20 is increased, the vibrating body 30 fixed to the elastic member 20 has a greater natural frequency (f₂) than a natural frequency (f₁) before the power (current) is applied.

Herein, to maximize vibration displacement or vibration force of the vibrating body 30, a vibrating frequency of the electromagnetic force by interaction of the coil 40 and the magnet 33 should be matched with the natural frequency (f₁ or f₂) of the vibrating body 30.

Therefore, it is preferable that to maximize the vibration displacement or the vibration force of the vibrating body 30 before the power (current) is applied to the elastic member 20, the power (current) with a frequency corresponding to the natural frequency (f₁) of the vibrating body 30 with the stiffness (K₁) before the power (current) is applied with to the elastic member 20, is applied to the coil 40, and to maximize the vibration displacement or the vibration force of the vibrating body 30 after the power (current) is applied to the elastic member 20, the power (current) with a frequency corresponding to the natural frequency (f₂) of the vibrating body 30 with the stiffness (K₂) after the power (current) is applied to the elastic member 20, is applied to the coil 40.

Meanwhile, in accordance with the first embodiment of the present invention, the vibrator 1 may further include an elastic member power control unit 60 for controlling the power (current) applied to the elastic member 20; and a coil power control unit 70 for controlling the power (current) applied to the coil 40 correspondingly to the power applied to the elastic member 20 through the elastic member power control unit 60.

That is, when the vibrator 1 in accordance with the first embodiment of the present invention is mounted on a device such as the portable terminal, the elastic member power control unit 60 may be installed to control the power (current) applied to the elastic member 20 from the power of the portable terminal and the coil power control unit 70 may be installed to control the power (current) applied to the coil 40 from the power of the portable terminal.

At this time, it is preferable that to maximize the vibration displacement or the vibration force of the vibrating body 30, the coil power control unit 70 is constructed to supply the coil 40 with the power (current) having a frequency corresponding to the natural frequency (f₁ or f₂) of the vibrating body 30 varied as the stiffness (K₁ or K₂) of the elastic member 20 varied by being blocked or applied with the power (current) to the elastic member 20 through the elastic member control unit 60.

Hereinafter, a controlling method of the vibrator constructed as described above in accordance with the first embodiment of the present invention will be described in more detail.

As shown in FIG. 12, in the controlling method of the vibrator in accordance with the first embodiment of the present invention, first of all, when a user intends to change a vibration mode of the vibrator (for example, a vibration mode of the portable terminal mounting the vibrator), the user selects power application to the elastic member 20 (S101).

Then, the elastic member power control unit 60 applies the power (current) to the elastic member 20 (S102).

At this time, the elastic member 20 is made of the shape memory alloy such as the Ni—Ti alloy of which physical properties are varied in a martensite phase and an austenite phase.

Accordingly, when the temperature of the elastic member 20 rises by being applied with power (current) to the elastic member 20, the stiffness of the elastic member 20 is changed to K₂ from K₁ as stiffness before applying the power (current) (S103).

In addition, when the stiffness of the elastic member 20 is changed from K₁ to K₂, the natural frequency of the vibrating body 30 is changed from f₁ to f₂ (S104).

And, when the natural frequency of the vibrating body 30 is changed from f₁ to f₂, the coil power control unit 70 applies to the coil 40 the power (current) with the frequency corresponding to the changed natural frequency f₂ of the vibrating body 30 (S105), and therefore the vibrating frequency of the electromagnetic force by interaction of the coil 40 and the magnet 33 of the vibrating body 30 is matched with the natural frequency (f₂) of the vibrating body 30 and the vibration displacement and the vibration force of the vibrating body 30 are maximized, whereby the vibrator 1 in accordance with the first embodiment of the present invention generates vibration with a vibration mode different from the vibration mode before the power (current) is applied to the elastic member 20 (S106).

Meanwhile, when the user intends not to change the vibration mode of the vibrator 1, the user does not select the power application to the elastic member 20.

That is, in accordance with the first embodiment of the present invention, the vibrator 1 blocks the power from the elastic member power control unit 60 to the elastic member 20 when the power application to the elastic member 20 is not selected by the user (S107).

Then, the elastic member 20 has the stiffness K₁ in the martensite phase (S108). At this time, the natural frequency of the vibrating body 30 becomes f₁ (S109).

Therefore, when the natural frequency of the vibrating body 30 becomes f₁ and the coil power control unit 70 applies to the coil 40 the power (current) with the frequency corresponding to the natural frequency f₁ of the vibrating body 30 (S110), because the vibrating frequency of the electromagnetic force by interaction of the coil 40 and the magnet 33 of the vibrating body 30 is matched with the natural frequency (f₁) of the vibrating body 30, the vibration displacement and the vibration force of the vibrating body 30 are maximized, whereby the vibrator 1 in accordance with the first embodiment of the present invention generates vibration having a vibration mode with the intrinsic stiffness K₁ before the power (current) is applied to the elastic member 20 (S106).

Meanwhile, as shown in FIG. 13 or FIG. 14, in the vibrator 1 in accordance with the first embodiment of the present invention, it is further possible that the vibrating body 30 is elastically supported inside the case 10 through an elastic member 20-1 composed of a flat panel type spiral spring with a linear cross section in a horizontal direction in stead of the elastic member 20 as shown in FIG. 2 to FIG. 6 composed of the spiral spring gradually projected downward from the outer part to the central part.

At this time, it is preferable that an outer part of the elastic member 20-1 composed of the flat panel type spiral spring is fixed to a side inside the case and a central part thereof is fixed to the vibrating body 30 to form a space for vibration in an axial direction (upward and downward) of the vibrating body 30.

In addition, although not shown, it is further possible that the vibrating body 30 is elastically supported inside the case 10 through the elastic member composed of the flat panel type linear spring instead of the flat panel type spiral spring.

A configuration and an operation in accordance with change of the vibration mode of the vibrator having the elastic member composed of the flat panel type spiral spring or the flat panel type linear spring as constructed above are the same as those of the vibrator in accordance with the first embodiment of the present invention, and therefore description thereof is omitted.

### Second Embodiment for a Vibrator

Hereinafter, a vibrator 2 in accordance with a second embodiment of the present invention will be described in more detailed with reference to the accompanying FIG. 15 and FIG. 16.

As shown in FIG. 15, in accordance with the second embodiment of the present invention, like the vibrator 1 in accordance with the first embodiment, a vibrator 2 similarly includes a case 210 forming an appearance of the vibrator 2; an elastic member 220 installed inside the case 210 and made of shape memory alloy of which physical properties are varied as power is applied from an outside of the case; a vibrating body 230 elastically installed inside the case 210 by the elastic member 220; a coil 240 installed inside the case 210 and vibrating the vibrating body 230 as the power is applied from the outside; and a support member 250 installed the coil 240 thereon.

However, in accordance with the second embodiment of the present invention, unlike the vibrator 1 in accordance with the first embodiment, the vibrator 2 further includes an external connection hole 211 formed on an upper surface of the case 210 and a vibration transmit member 280 for transmitting outside vibration generated from the vibrating body 230 by being connected to the vibrating body 230 and further being extended outside the case 210 through the external connection hole 211 of the case 210.

Herein, the vibration transmitting member 280 may be a shaft connected to an external device (not shown) by one side thereof being fixed to the vibrating body 230 and the other side thereof being extended outside the case 210 through the external connection hole 211 of the case 210.

That is, it is possible to transmit reciprocally vibrated movement of the vibrating body 230 to the external device connected to the other side of the vibration transmitting member 280 by the medium of the vibration transmitting member 280 by reciprocating-vibrating the vibrating body 230 below and above the case 210.

That is to say, in accordance with the second embodiment of the present invention, the vibrator 2 has multi-functions to generate vibration through the vibrating body 230 and also to transmit the vibration movement of the vibrating body 230 to the external device through the vibration transmitting member 280.

At this time, it is preferable that the elastic member 220 has a type not be interfered with the vibration transmitting member 280 to smoothly perform the installation and the transmitting of the vibration outside the vibration transmitting member 280.

That is, when the elastic member 220 is a spiral spring of which an outer part is fixed inside the case 210 and a central part is fixed to the vibrating body 230, a through hole 225 through which the vibration transmitting member 280 passes is formed, thereby preventing the vibration movement of the vibration transmitting member 280 from being interfered by the elastic member 220.

Further, as shown in FIG. 16, when an elastic member 220-1 is composed of a flat panel type linear spring instead of a spiral spring, it is further preferable to have various types not being interfered with the vibration transmission member 280.

Meanwhile, in accordance with the second embodiment of the present invention, like the vibrator 1 in accordance with the first embodiment, the vibration 2 further preferably includes an elastic member power control unit 260 for controlling the power (current) applied to the elastic member 220 and a coil power control unit 70 for controlling the power (current) applied to the coil 240 corresponding to the power applied to the elastic member 220 through the elastic member power control unit 260.

Herein, it is more preferable that the coil power control unit 270 is constructed to supply the coil with the power (current) having a frequency corresponding to the natural frequency of the vibrating body 230 varied as the power (current) is applied to the elastic member 220.

And, the vibrating body 230, like the vibrating body in accordance with the first embodiment, may include a yoke 231, a weight body 232 and a magnet 233.

A configuration and an operation in accordance with change of the vibration mode of the vibrator in accordance with the second embodiment of the present invention are the same as those of the vibrator 1 in accordance with the first embodiment of the present invention, and therefore description thereof is omitted.

As described above, in accordance with the embodiment of the present invention, a vibrator, a controlling method thereof and a portable terminal provided with the same are capable of being downsized, diversifying a vibration mode and improving the performance.

As described above, although a few preferable embodiments of the present invention have been shown and described, it will be appreciated by those skilled in the art that substitutions, modifications and changes may be made in these embodiments without departing from the principles and spirit of the general inventive concept, the scope of which is defined in the appended claims and their equivalents.

1. A vibrator comprising:
a case;
an elastic member installed inside the case and made of shape memory alloy of which physical properties are varied as power is applied from an outside of the case;
a vibrating body elastically installed inside the case by the elastic member; and
a coil installed inside the case and vibrating the vibrating body as the power is applied from the outside.

2. The vibrator according to claim 1, wherein the case includes a predetermined thickness to form a space inside, is formed in a cylindrical shape with an opened lower part and includes a support member installed on a lower part of the case to fix the coil on a top surface of the support member.

3. The vibrator according to claim 1, wherein the support member is composed of a substrate with a connection device formed on a bottom surface for applying power to the coil.

4. The vibrator according to claim 3, wherein the connection device is composed of a metallic member or a conductive pattern electrically connected to the coil.

5. The vibrator according to claim 1, wherein the elastic member is made of Ni—Ti alloy of which physical properties such as an elastic modulus and a yield strength are varied as a martensite phase and an austenite phase.

6. The vibrator according to claim 5, wherein the Ni—Ti alloy is preferably in the ratio of 55% of Ni and 45% of Ti.

7. The vibrator according to claim 1, wherein the elastic member is a plate type spring of which an outer part is fixed to an inside surface of an upper part of the case and a central part is fixed to the vibrating body.

8. The vibrator according to claim 7, wherein the plate type spring includes a plurality of types divided with respect to the central part bidirectionally.

9. The vibrator according to claim 1, wherein the elastic member is a spiral spring of which an outer part is fixed inside the upper part of the case and a central part is fixed to the vibrating body.

10. The vibrator according to claim 9, wherein the spiral spring includes an outer ring unit for forming the outer part, an inner ring unit for forming the central part and an arch unit for connecting the outer ring unit and the inner ring unit.

11. The vibrator according to claim 1, wherein the vibrating body includes:
a yoke for receiving elastic force in an axial direction of the case by being fixed to the elastic member;
a weight body fixed to a circumference of the yoke; and
a magnet fixed to a center of the yoke.

12. The vibrator according to claim 1, wherein the coil is a voice coil.

13. The vibrator according to claim 1, further comprising:
an elastic member power control unit for controlling the power applied to the elastic member; and
a coil power control unit for controlling the power applied to the coil by corresponding to the power applied to the elastic member through the elastic member power control unit.

14. The vibrator according to claim 13, wherein the coil power control unit supplies the coil with the power with a frequency corresponding to the natural frequency of the vibrating body varied as the power is applied to the elastic member.

15. A method for controlling the vibrator comprising:
selecting whether power is applied to an elastic member or not;
controlling the power applied to the elastic member from an elastic member power control unit according to a power application state of the elastic member; and
controlling the power applied to a coil from a coil power control according to the power application state of the elastic member.

16. The method according to claim 15, wherein controlling the power applied to the coil includes applying to the coil the power with a frequency corresponding to the natural frequency of the vibrating body varied according to a power application state of the elastic member from the coil power control unit.

17. A vibrator comprising:
a case with an external connection hole formed therein;
an elastic member installed inside the case and made of shape memory alloy of which physical properties are varied as power is applied from an outside of the case;
a vibrating body elastically installed inside the case by the elastic member;
a coil installed inside the case and vibrating the vibrating body as the power is applied from the outside; and
a vibration transmitting member for transferring outside the vibration generated from the vibrating body by one side thereof being connected to the rotating body and the other side thereof being extended outside the case.

18. The vibrator according to claim 17, wherein the vibration transmitting member is a shaft connected to an external device by one side thereof being connected to the rotating body and the other side thereof being extended outside the case through the external connection hole of the case.

19. The vibrator according to claim 17, wherein the elastic member is a plate type spring fixed to the vibrating body such that an outer part is fixed inside the case and a central part is not interfered with the shaft.

20. The vibrator according to claim 17, wherein the elastic member is a spiral spring fixed to the vibrating body such that the outer part is fixed inside the case and the central part is not interfered with the shaft.

21. The vibrator according to claim 17, further comprising:
an elastic member power control unit for controlling the power applied to the elastic member; and
a coil power control unit for controlling the power applied to the coil by corresponding to the power applied to the elastic member through the elastic member power control unit.

22. The vibrator according to claim 21, wherein the coil power control unit supplies the coil with the power with a frequency corresponding to the natural frequency of the vibrating body varied as the power is applied to the elastic member.

23. A portable terminal provided with a vibrator comprising:
a case,
an elastic member installed inside the case and made of shape memory alloy of which physical properties are varied as power is applied from an outside of the case,
a vibrating body elastically installed inside the case by the elastic member,
and a coil installed inside the case and vibrating the vibrating body as the power is applied from the outside.
